(19) United States
(12) Patent Application Publication
(10) Pub. No.: US 2003/0024770 A1
(43) Pub. Date: Feb. 6, 2003

(54) Elevator belt assembly with waxless coating

(76) Inventors: Hugh James O'donnell, Longmeadow, MA (US); John Peter Wesson, Vernon, CT (US); Christoph Denger, Kuesten (DE); David E. McKee, Somers, CT (US)

Correspondence Address: OTIS ELEVATOR COMPANY, INTELLECTUAL PROPERTY DEPARTMENT, 10 FARM SPRINGS, FARMINGTON, CT, 06032, US

(21) Appl. No.: 09/921,803

(22) Filed: Aug. 3, 2001

(51) Int. Cl. B66B 9/00; B66B 7/06; D02G 3/12

(52) U.S. Cl. 187/251

(57) ABSTRACT

A roping or belt assembly in an elevator system includes at least one load bearing member that is covered using a urethane coating. The urethane coating does not contain any waxes. The absence of the waxes, which are otherwise typically included in urethane coatings, ensures better friction characteristics in elevator system operation.

### BACKGROUND OF THE INVENTION

This invention generally relates to elevator belts or ropes having at least one load bearing member with a coating. More particularly, this invention relates to an elevator rope or belt assembly having a waxless urethane coating.

Elevator systems typically include a cab for carrying passengers between landings in a building. A counterweight is often associated with the cab. The counterweight and cab typically are coupled using a rope or belt. In some configurations, the rope or belt includes a plurality of load bearing members such as steel cords or strands. The load bearing members typically are coated with a urethane coating.

One difficulty associated with conventional urethane coatings is that the urethane material typically includes one or more waxes. The waxes typically are included as part of the urethane manufacturing process. The wax typically is included, at least for facilitating later molding processes because the wax makes it easier to remove a final product from a mold.

A particular difficulty presented by the presence of such waxes in elevator systems is that the wax tends to reduce friction between the roping or belt and the associated sheaves in the elevator system. Over time, the wax can build up on the sheaves, which further reduces the friction characteristics within the elevator system. Because friction is necessary to drive the elevator system components and move the cab as desired, any wax or other material that reduces friction is undesirable.

Accordingly, there is a need for a increased friction arrangement for coated roping or belts in an elevator system. This invention addresses that need while avoiding the shortcomings and drawbacks of prior arrangements discussed above.

### SUMMARY OF THE INVENTION

In general terms, this invention is an elevator roping or belt assembly that has a waxless coating. An assembly designed according to this invention includes at least one load bearing member. In one example, a plurality of metallic strands or cords are load bearing members. A urethane coating on the load bearing member does not contain any wax.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates an elevator system including an assembly designed according to this invention.

FIG. 2 schematically illustrates an elevator roping assembly designed according to this invention.

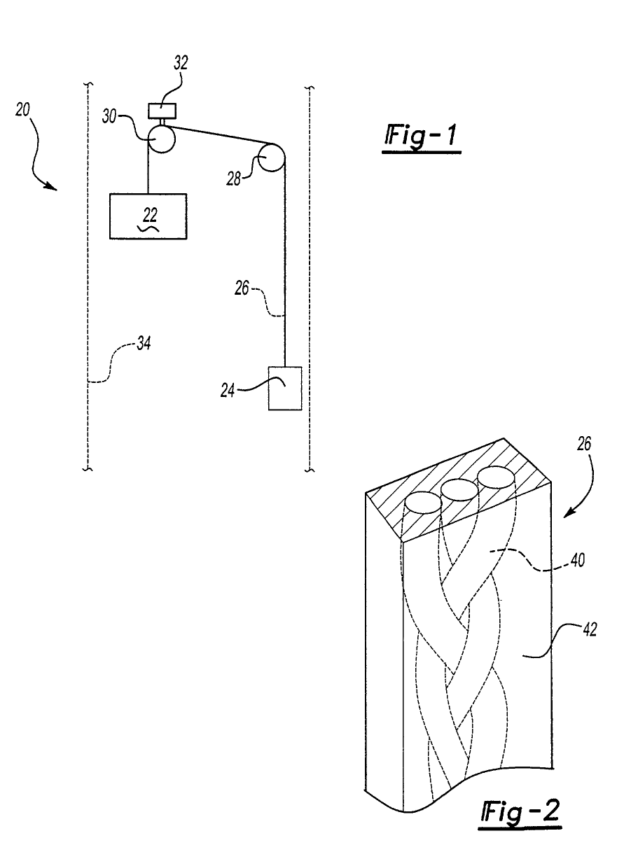

### DETAILED DESCRIPTION OF A PREFERRED EMBODIMENT

An elevator system 20 includes a cab 22 for carrying passengers between a plurality of landings (not illustrated) within a building. A counterweight 24 is coupled with the cab 22 by at least one load bearing assembly 26. The load bearing assembly 26 may be a roping assembly or a belt, depending on the particular configuration required for a particular elevator system. This invention is not limited to “ropes” or “belts” in the strictest sense. Either is within the scope of this invention. Therefore, the use of the term “rope” or “belt” within this specification should not be limited in its strictest sense, but the two should be considered interchangeable or synonymous as appropriate.

Sheves 28 and 30 guide the belt 26 along a chosen path to move the cab 22 between the various landings. A conventional drive mechanism 32 is associated with the sheave 30 to drive the belt and move the elevator components as desired. The counterweight 24 and cab 22 move within a hoistway (illustrated in phantom at 34) in a conventional manner.

The belt assembly 26 preferably includes a plurality of load bearing members 40, which may be metallic or non-metallic aramids, for example. Examples of such load bearing members include cords or strands. The load bearing members are arranged in a conventional fashion (such as helical winding) to provide the desired strength characteristics within a particular elevator system.

A urethane coating 42 is secured to the load bearing members 40. At least a portion of the load bearing members are covered with the urethane coating 42. In some examples, the load bearing members 40 are completely encased in the urethane coating 42.

The urethane coating 42 preferably is a thermal polyurethane material. The urethane coating does not contain any waxes. The typical stearate-based waxes that are routinely added to urethane materials are not included in the urethane coating 42. Therefore, the urethane coating 42 preferably is waxless.

Because there is no wax added to the urethane coating 42, the process of making a belt assembly 26 designed according to this invention is somewhat different than conventional belt manufacturing processes. For example, a mold wheel that is used as part of forming the belt assembly 26 preferably is coated with a release agent to ensure part consistency and proper release from the mold. Given this description, those skilled in the art will be able to choose from among commercially available and suitable release agents. The release agent is added to compensate for the absence of the wax from the urethane material.

Additionally, the tooling used to make the belt assembly 26 preferably includes a pull-off mechanism that is stronger than typically required because of the absence of wax from the urethane material, which otherwise facilitates removal from the mold. Additionally, it is believed that adjustments to the cutting process may be necessary to ensure exact product dimensions for quality control. Given this description, those skilled in the art will realize the types of tooling adjustments necessary to compensate for the absence of the waxes from the urethane material used to make the coating 42.

An elevator roping assembly designed according to this invention provides superior friction characteristics within an elevator system. The waxes that otherwise interfere with friction and which may build up on sheaves within the elevator system are eliminated, and therefore a more consistent operation is achieved.

The preceding description is exemplary rather than limiting in nature. Variations and modifications to the disclosed embodiment may become apparent to those skilled in the art that do not necessarily depart from the purview and spirit of this invention. The scope of legal protection given to this invention can only be determined by studying the following claims.

We claim:

1. An elevator rope assembly, comprising:
at least one elongate load carrying member; and
a urethane coating on the load carrying member that does not contain wax.

2. The assembly of claim 1, wherein the coating comprises a waxless thermal polyurethane.

3. The assembly of claim 1, including a plurality of load carrying members wound together and wherein the coating encases an outer portion of the plurality.

4. The assembly of claim 1, wherein the load carrying member comprises a plurality of metallic strands.

5. The assembly of claim 1, wherein the load carrying member comprises a plurality of non-metallic strands.

6. A method of making an elevator rope assembly, comprising:
arranging a plurality of elongate load carrying members in a selected arrangement; and
coating the load carrying members with a urethane coating that does not contain wax.

7. The method of claim 6, including using a thermal polyurethane coating.

8. The method of claim 6, including positioning the load carrying members within a mold and applying a release agent to the mold to enhance an ability to remove the rope assembly from the mold after the load carrying members are coated with the urethane coating.

9. An elevator system, comprising:
a cab;
a counterweight; and
a load bearing assembly coupling the cab to the counterweight having a plurality of elongate load carrying members and a urethane coating on the load carrying members that does not contain wax.

10. The system of claim 9, wherein the coating comprises a waxless thermal polyurethane.

11. The system of claim 9, wherein the load carrying members are steel cords and the urethane coating encases the plurality of steel cords.

12. The system of claim 9, wherein the load carrying members are non-metallic strands and the urethane coating encases the plurality of strands.
